(19) United States
(12) Patent Application Publication
(10) Pub. No.: US 2012/0246087 A1
(43) Pub. Date: Sep. 27, 2012

(54) Method and apparatus for establishing an exclusive network of Strong Tie connections which is then used to make referenceable connections between members for various personal and business benefits

(76) Inventors: Naresh Talati, Voorhees, NJ (US); Niranjan Mehta, Manalpan, NJ (US)

(21) Appl. No.: 13/373,533

(22) Filed: Nov. 17, 2011

Related U.S. Application Data
(60) Provisional application No. 61/415,436, filed on Nov. 19, 2010.

(51) Int. Cl. G06Q 99/00

(52) U.S. Cl. 705/319

(57) ABSTRACT

Method and apparatus for establishing an exclusive network of Strong Tie connections which is then used to make referenceable connections between members for various personal and business benefits. In real life, everyone has close relationships with a few people who provide emotional support to the member and also influence member's purchase as well other important decisions. These are Strong Tie connections. As the network is limited to only Strong Tie connections, it enables various purpose driven applications without any member having direct access to other member data. Applications include Connect, Find Match, Find Person, Group Buy and Job Search. For example, through this network, members can make referenceable connections with other members who are important for personal and business reasons and who they do not know personally but are known to their Strong Tie connections or Strong Ties of Strong Ties and so on.

### CROSS REFERENCE TO RELATED APPLICATIONS

This application is based on provisional application Ser. No. 61/415,436, filed on Nov. 19, 2010.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of Social Network and more specifically to method and apparatus for establishing an exclusive Social Network of Strong Tie connections which is then used to make referenceable connections between members for various personal and business benefits.

Social Networks Service: A social networking service is an online service, platform, or site that focuses on building and reflecting of social networks or social relations among people, who, for example, share interests and/or activities. A social network service consists of a representation of each user (often a profile), his/her social links, and a variety of additional services. Most social network services are web-based and provide means for users to interact over the Internet. Social network service usually means an individual-centered service. Social networking sites allow users to share ideas, activities, events, and interests within their individual networks. Social network services are widely used around the world. A 2011 survey found that 47% of American adults use a social network.

Social Networking sites began to flourish with the emergence of SixDegrees.com in 1997, followed by Makeoutclub in 2000, and Friendster in 2002. In 2003, MySpace and LinkedIn were introduced. In 2004, Facebook was launched and it is currently largest social networking site with about 800 million members. Currently, LinkedIn has about 100 million members.

Search Engine: A search engine is designed to search for information on the World Wide Web and FTP servers. The search results are generally presented in a list of results often referred to as SERPS, or “search engine results pages”. The information may consist of web pages, images, information and other types of files.

Around 1996, search engine became popular with emerge of Netscape's web browser. In 1996, five popular Yahoo!, Magellan, Lycos, Infoseek, and Excite. Microsoft started its own broswer in 1998. Around 2000, Google's search engine rose to prominence. The company achieved better results for many searches with an innovation called PageRank. Google maintained a minimalist interface to its search engine. In contrast, many of its competitors embedded a search engine in a web portal.

In 2004, Yahoo and Microsoft, started using its own search engine. In 2009, Yahoo and Microsoft made a deal to use search engine using Microsoft Bing technology.

Facebook is the most popular social networking site. It allows you to build large network of people irrespective of your relationship with them. It is not targeted towards making does not allow people to connect thro

[symbol]

LinkedIn is a professional networking site which allows you to establish professional connections with large number of people irrespective of your relationship with them. Member can connect to their 1st level connections directly and can find out about 2nd level connections. Member can connect to any person within network through internal message system. However, member cannot find out how other person is related to member in terms of intermediaries and in terms of relations. Search is limited to professional data.

Google and Bing are the most popular search engines today. They provide available information from world wide web which may not be reliable.

Research of Social Networks Indicate:

That people may have large number of friends on social networks, but they have strong ties with only a few of them:
Overall, people have about 150 “friends” that they are in touch with at any point in their life
Everyone around the world usually maps these friends in 4-6 groups
Every group has typically 2-10 people with strong ties and rest with weak ties
Overall, we believe that people typically have strong ties with 20-40 people across all groups put together
In real life people don't call them “Friends” even though popular networks have adopted that terminology.

That these Strong Ties influence decisions people make . . .
People make everyday decisions based on inputs from their strong ties and not based on business advertisements
“Strong Ties” of “Strong Ties” and so on are seen as highly valuable resources . . . more so than their own “Weak Ties”

Facebook Types of Social Networks:

Current social networks like Facebook facilitates “Keeping in Touch” with large number of “Weak Ties” relationship. However, People depend on ‘Strong Ties” for everyday decisions and emotional support for important matters of family & business. The proposed Strong Ties network facilitates this.

Large number of “Weak Ties” limits amount of knowledge people have about each other and what they are willing to share with each other. Proposed Strong Ties network limits number of people in network to “Strong Relationship” only and hence this network could have more knowledge on each member that would be useful to each other in their own network.

“Weak Tie” of a “Weak Tie” is not a valued connection. While ‘Strong Tie’ of a ‘Strong Tie’ is a valued connection and hence member value opinion of ‘Strong Tie’ member.

In summary, current social networks, like Facebook, are “Keeping in Touch with a Large Number of Weak Ties for Time Pass” while the proposed Strong Ties network is “Enrich Lives By Leveraging Power of Strong Ties”.

LinkedIn Types of Professional Networks:

The proposed Strong Tie network differs from the LinkedIn types of professional networks in terms of its size and use. With LinkedIn type network, member can have infinite size of network of professional connections. With the Strong Tie network, you can have only limited number of connections for personal and business connections. Also, with Strong Tie network, tour connections are limited to three levels.

Google Types of Search Engines:

The proposed Strong Tie network differ from Google and other search engines whereby they search only within member's strong tie connection network for specific type of information, and thereby offering reliable information that is endorsed by members' strong tie connections.

Finally, the proposed Strong Tie Network combines is an intelligent integration of concepts of “Social Networks”, “Connection Maps” and ‘Search Engines”. They use social networking concept to establish multilevel networking connections. They use connection maps to bring to foreground “less-known” connections. In addition, they use search engine concept to enable members to find what they are looking for with ease.

### BRIEF SUMMARY OF THE INVENTION

The primary object of the invention is to build an exclusive network of Strong Tie members and then provide numerous applications that enable significant personal and business benefits to members.

Another object of the invention is to build a support structure of Strong Ties for everyday decisions and emotional support for important matters of family & business.

Another object of the invention is facilitate more member data sharing to build community database without anyone having direct access to other member's data.

Another object of the invention is to develop various purpose driven applications using the community database.

Another object of the invention is to allow member find person within the network and make connection with person knowing how member is connected to a person, including intermediaries and relationship of each intermediary.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed Method and apparatus for establishing an exclusive network of Strong Tie connections which is then used to make referenceable connections between members for various personal and business benefits comprising: (a) A means by which each member can identify and establish a limited number of close friends, family members and/or coworkers as their direct network, referred to from here on as a Strong Tie Connections, and (b) A means by which each of said Strong Tie Connections can then go on to identify and establish their own limited number of Strong Tie Connections and so on thereby establishing a network of referenceable connections, and (c) A means by which members can leverage their network of referenceable connections for social and/or professional gains and/or mutual benefit, and (d) A means by which members can access information about the basis of their relationship to another member through a network of intermediaries while maintaining appropriate confidentiality and (e) enable various purpose driven applications (Examples: Connect, Find Match, Find Person, Group Buy, Job Search) without any member having direct access to other member data.

The disclosed embodiments are an intelligent integration of concepts of “Social Networks”, “Connection Maps” and ‘Search Engines”. They use social networking concept to establish multilevel networking connections. They use connection maps to bring to foreground “less-known” connections. In addition, they use search engine concept to enable members to find what they are looking for with ease.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a block diagram depiction of a system that incorporates a social network service, under an embodiment of the invention.

FIG. 2 shows a potential member's strong tie connection network with different types of strong tie connections at different levels.

FIG. 3A illustrates a method that illustrates an overview of a social network service where by member can make a reference able connection with the desired target member who is not in member's own strong tie connection network. FIG. 3B illustrates user interface for the method and a typical connection chain search result.

FIG. 4 illustrates another method that illustrates an overview of a social network service where by member can get connected with service providers recommended by his strong tie connection network members.

FIG. 5 illustrates another method that illustrates an overview of a social network service where by member can find another member person in his strong tie connection network anywhere in the world.

FIG. 6 illustrates another method that illustrates an overview of a social network service where by member can find prospective matrimonial matches. FIG. 6A shows user interface for this service.

FIG. 7A-7C illustrate another method with user interfaces that illustrates an overview of a social network service where by member can form a group who want to buy the same product/service in the same time frame so that group can have group purchasing power.

FIGS. 8A, 8B illustrate another method that illustrates an implementation of a social network service where by member can find a companion(s) to go on vacation together based on mutual preferences.

FIG. 9 illustrates another method that illustrates an implementation of a social network service where by member can search for a job and apply for it after finding from the system referenceable connections with the job-poster.

FIG. 10 illustrates another method that illustrates how a member can send message to selected members based on selected criteria. FIG. 10A illustrates how broadcast messages are displayed to user based on its relevance.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Overview:

Everyone has a small group of people they count on for help and to make everyday decisions in their personal and professional lives. They care most about these people. They have formed relationships with these people at different stages of their lives where they have shared experiences. They have “Strong Ties” with these people and they rely on them for emotional support throughout life. People often refer to these people with strong ties as their “circle of trust.”

Additionally, people have connections with a larger group of people with whom they interact occasionally. These large groups are not viewed as people who influence their everyday decisions. In other words, these are people with whom they have “Weak Ties”. Current social networks do not differentiate between “Strong Ties” and “Weak Ties”. Hence, people are afraid to use them for emotional support. Current social networks also do not facilitate decision making.

The disclosed embodiments describes how to form social network among this “Strong Ties” and provide numerous methods and implementations of this strong tie connection network to improve member's social life, facilitate decision making and provide emotional support for important matters of family & business.

The disclosed embodiments are an intelligent integration of concepts of “Social Networks”, “Connection Maps” and ‘Search Engines”. They use social networking concept to establish multilevel networking connections. They use connection maps to bring to foreground “less-known” connections. In addition, they use search engine concept to enable members to find what they are looking for with ease.

The disclosed embodiments differ from Facebook and other social networks whereby focus is on building trusted reference able connections, which are mapped to find/connect with the right resources. As described in one of the embodiment, this is accomplished by limiting the number of Trusted Ties in line with real-life scenarios in most cases.

The disclosed embodiments differ from the LinkedIn in terms of its size and use. With LinkedIn member can have infinite size of network of professional connections. With the disclosed embodiments, you can have only limited number of connections for personal and business connections. Also, your network is limited to three levels of connections.

The disclosed embodiments differ from Google and other search engines whereby they search only within member's strong tie connection network for specific type of information, and thereby offering reliable information that is endorsed by members' strong tie connections.

In an embodiment, a social network of strong tie connections may be established. Member can have only limited number of invitees. However, member can accept unlimited number of invitations. By limiting number of invitees, system encourages member to invite only people with strong tie connections. Invited Person does not need to be a member of the described social network method to accept the invitation.

In another embodiment, system mandates only minimal personal and family information and encourages member to easily enter other information like, service providers they recommend, vacation they plan to take, interests. System asks for missing non-mandated information, one at a time at various times, including at follow on log-ins and when members do searches. System asks for this information, in non-intrusive way at right time when member will more likely to provide the information.

Other multiple embodiments describe some possible search methods. Following are some illustrative examples:
1. Find who are common ties between you and someone important to you for professional or personal reasons
2. Find service providers in your connection network who are recommended in your city Or any city around the world
3. Find people in your connection network who specialize in a profession Or are from the same university as you Or belong to the same ethnicity Or religion as you in any city around the world?
4. Find a person in your strong tie connection network anywhere in the world.
5. Identify prospective matrimonial matches
6. Facilitate forming a group of people who want to buy the same product/service so that group can have purchasing power of a group
7. For Service Providers, acquire new members based on references
8. Find a companion(s) to go on vacation together based on mutual preferences
9. Post a job to in your network. Find a job, connection with job-poster and apply for job.

System Overview and Methodology

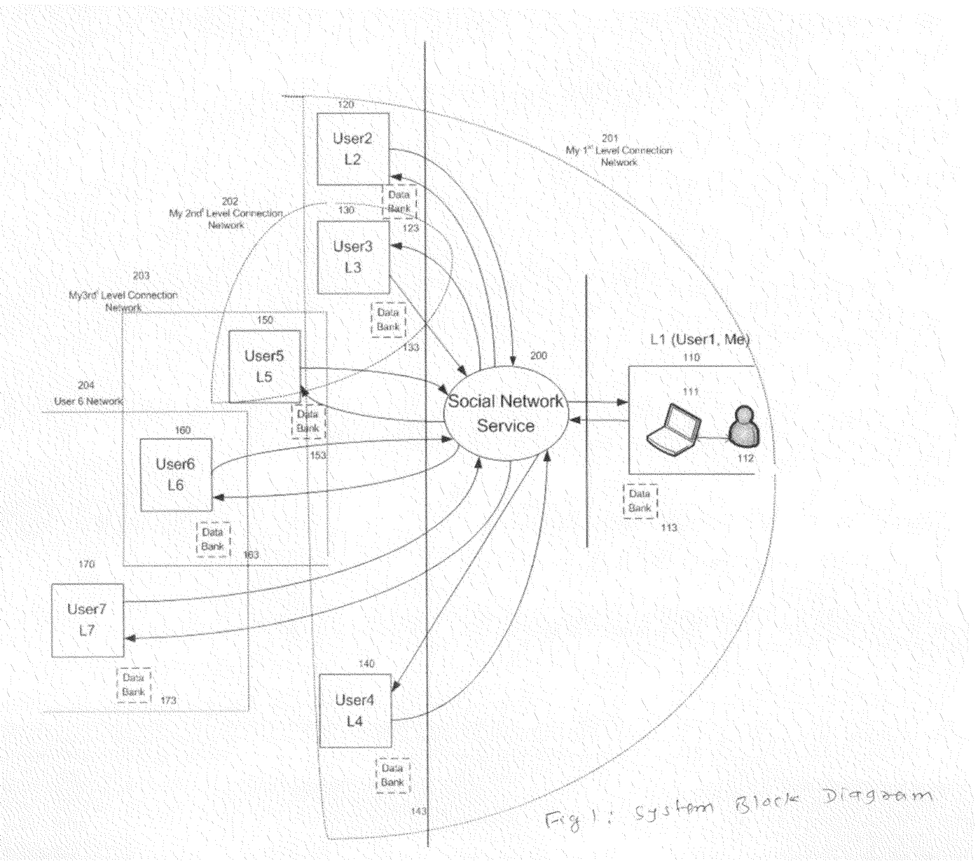

In accordance with the present invention, FIG. 1 shows a block diagram depiction of a system that incorporates a social network service 200 which provides method and apparatus of establishing an exclusive network of Strong Tie connections. The social network service 200 may be provided by one or more modules that execute on one or more servers. Each server is connected to data network. Data network includes Internet, Cellular Network and Public Network. Terminal 111 provides user interface to User 112. Terminal can be any computing device with a capability to connect to a data network.

User1 (110) registers with Social Network Service 200 and fills out User1's databank 113. Databank 113 consists of personal data and non-personal data. Every user has to fill out personal data in order to become a member. Personal data is never revealed to anyone. Non-personal data is optional however system facilitates ease of putting non-personal data during registration and other times. Non-personal data consists of information which is useful to member's connection network. This includes member's recommended service providers and places, vacation places member want to go, family accomplishment member is proud of, member's everyday heroes and family members accomplishments member is proud of.

During registration or any time after that User1 (110) invites a limited number of close friends, family members and/or coworkers to become User1′s direct network, referred to from here on as a L1 strong tie connections. Since each member can have only limited number of direct strong tie connections, member invites only limited number of people. Invited person(s) may or may not accept User1 (110) invitation. Invited person does not have to be a member of Social Network Service 200 in order to accept invitation from User1 (110).

In FIG. 1, User1 (110) sent invitations to User2 (120), User3 (130) and User4 (140) and they accepted the invitation. Hence they became User1 (110) direct or L1 strong tie connections.

Each of User1 (110) L1 strong tie connections can then go on to identify and establish their own limited number of Strong Tie Connections and so on thereby establishing a network of referenceable connections. User3 (13) sent invitation to User5 (150) and he/she accepted the invitation. Hence user5 (150) became User3's (130) L1 strong tie connection.

Since User3 (130) has L1 strong tie connection with User1 (110), User5 (150) becomes User1's (110) L2 strong tie connection. User6 (160) accepted the invitation from User5 (150) and hence user6 (160) became User5 (150) L1 strong tie connection. Since User5 (150) has L2 strong tie connection with User1 (110), User6 (160) becomes User1's (110) L3 strong tie connection. In FIG. 1, User1's (110) strong tie connection network consists of User1's L1 (120, 130, 140), L2 (150) and L3 (160) strong tie connections. Note that User7 (170) is not a part of User1's (110) network even though User7 (170) is User6's (16) L1 strong tie connection since that is a User1's (110) L4 strong tie connection.

In an embodiment, User1 (110) has multiple search methods. User1 (110) uses terminal 111 to select a method and submits a search to the service 200. Service 200 searches User1's strong tie connection network members' databanks. Service 200 provides an option to user so that user can select the search across all the databanks in service 200.

By keeping one data bank for each family with separate account for each family member, this invention builds a social network for families to network with other families through their referenceable network.

As illustrated through some of the applications in this patent, using this invention members can leverage their network of referenceable connections for social and/or professional gains and/or mutual benefits.

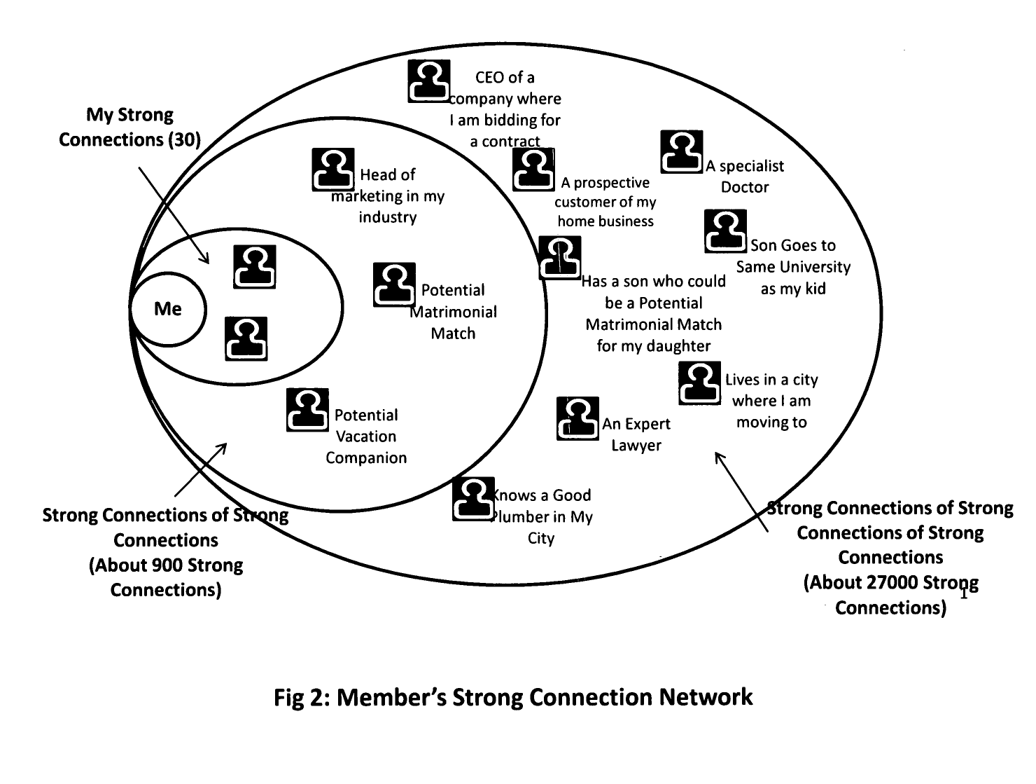

FIG. 2 illustrates Member's Strong tie Connection Network. In this example, each member can have up to 30 direct (L1) strong tie connection members. In FIG. 2, member has up to 900 L2 strong tie connection members and up to 27000 L3 strong lie connection members. So member's Strong tie Connection Network has maximum of 27931 members. FIG. 2 also illustrates typical hidden connections member may be looking for.

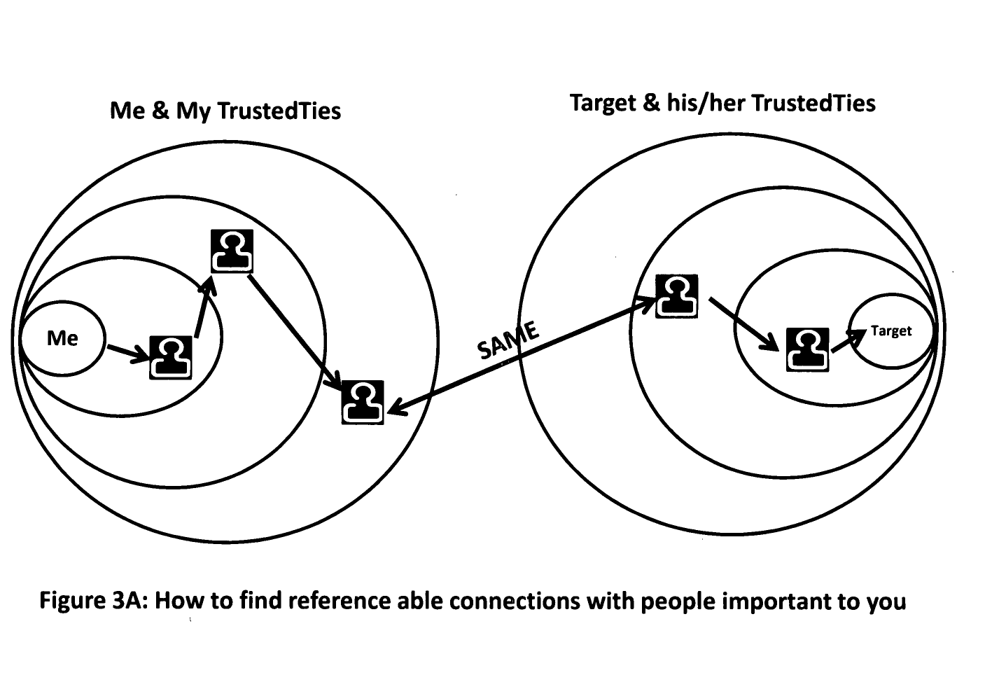

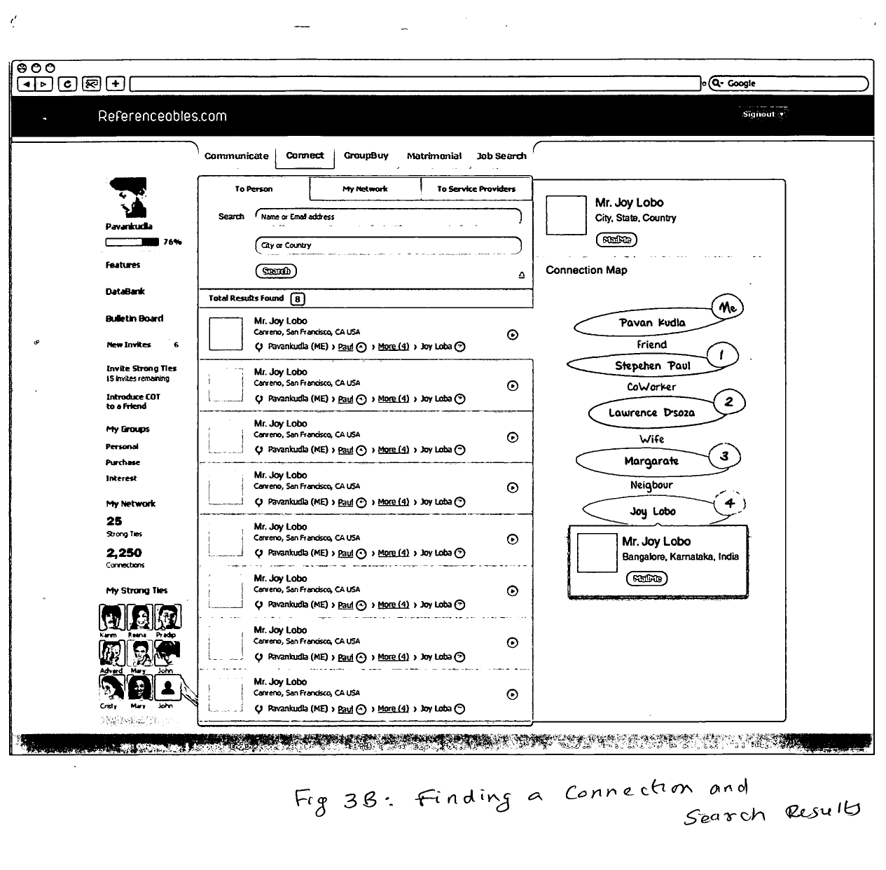

FIG. 3A illustrates a method to find a reference able connection with a target member within Service 200. Member uses this method to find how member is connected to a target member. Member may use this method for personal or professional reason. Member can find the reference able connection with the target member who is up to five level of separation. The method provides member capability to search for the target person. Once the target person is found, service 200 finds the connection chain between member and target member. Members can access basis of their relationship to target member through a network of intermediaries while maintaining appropriate confidentiality. FIG. 3B illustrates conceptual user interface for the method and a typical connection chain search result.

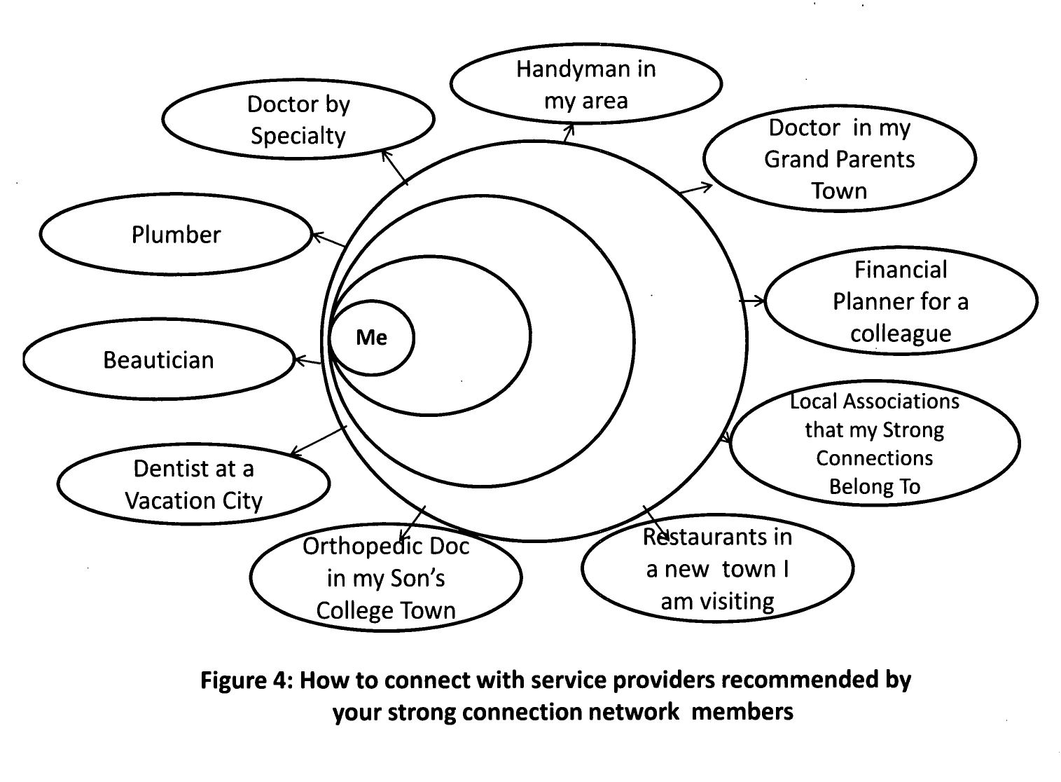

FIG. 4 illustrates another method to find service providers recommended by member's strong tie connection members. It shows typical types of reference able service providers you may need in member's residence area or anywhere in the world.

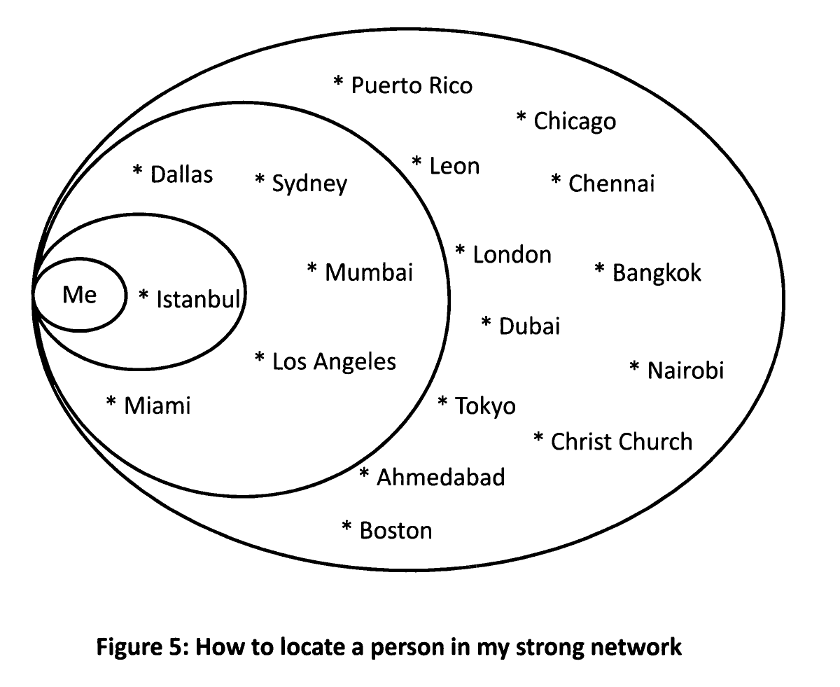

FIG. 5 illustrates another method to locate a person in member's strong tie connection network. Member can search for a person(s) by one or more criteria, including residence place, Ethnicity, Religion, Profession, Universities attended and connection level. Service 200 provides all the matched results. Member can zoom-in to find how the selected member is connected to member. Member can use this method for many purposes. Following are some examples:
1. Find member(s) located at the place he/she plans to visit
2. Find member(s) of specific ethnicity where member resides or where member plans to move or visit
3. Find member(s) with specific interest where member resides

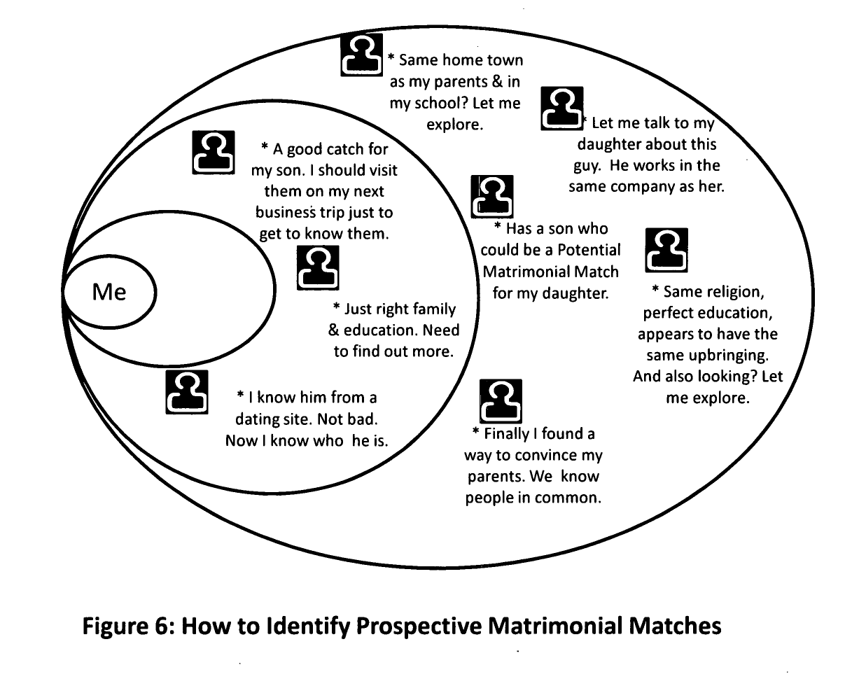

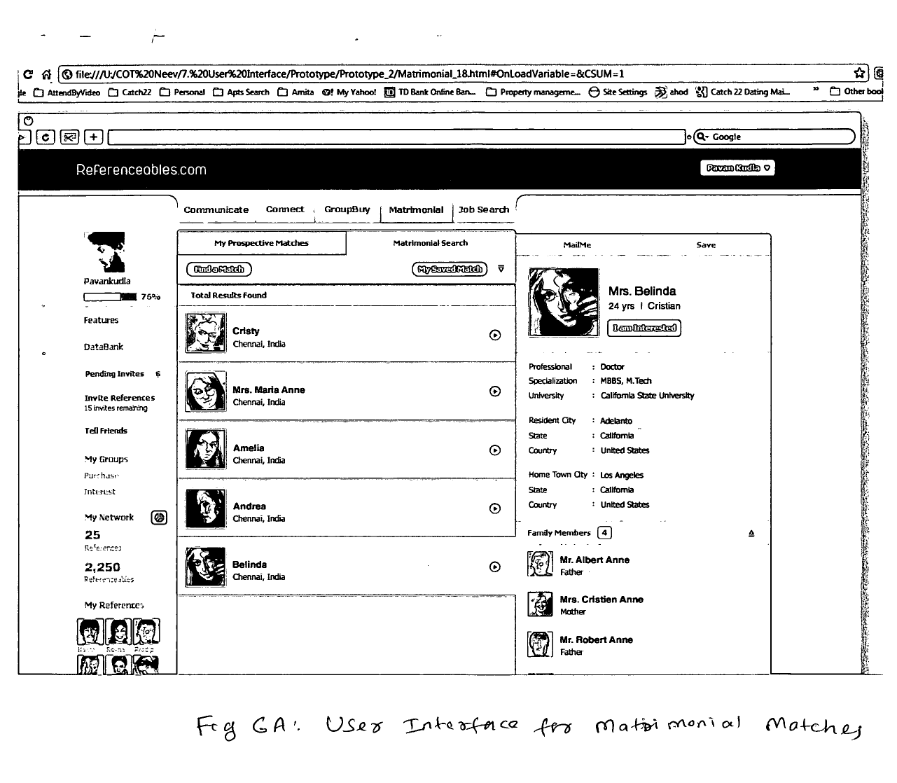

FIG. 6 illustrates conceptual diagram of another method that serves to provide matrimonial matching for self or family members. FIG. 6A shows the user interface for this method. Using this method, members can identify their matrimonial needs, and/or the needs of their family members. Using this method members can search for suitable matches amongst the members and family members interested in matrimonial matches on the basis of search criteria focused on family background as well as personal background including but not limited to age, religion, ethnicity, profession, location, education, hometown, languages spoken, financial status, and family values. Once a match is found, Service 200 provides information about how they are connected to a potential match through a network of referenceables. Once a member has interest in the found match, Service 200 allows member to show interest in connecting with the match or their family members for his/herself or for his/her family members while maintaining complete confidentiality with only the system itself gaining knowledge of said member's proposed interest until mutual interest has been established.

Service 200 provides an option to find a person from member's own strong tie connection network or from all the members Service 200 has. Service 200 also allows member to be alerted when a prospective match(s) become available.

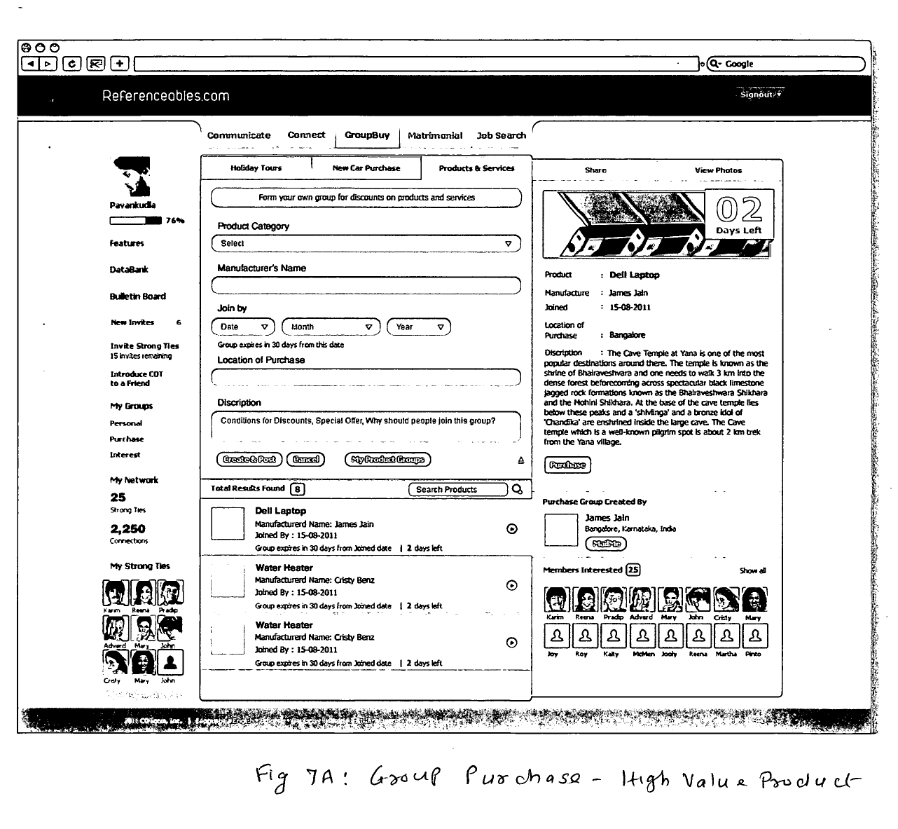

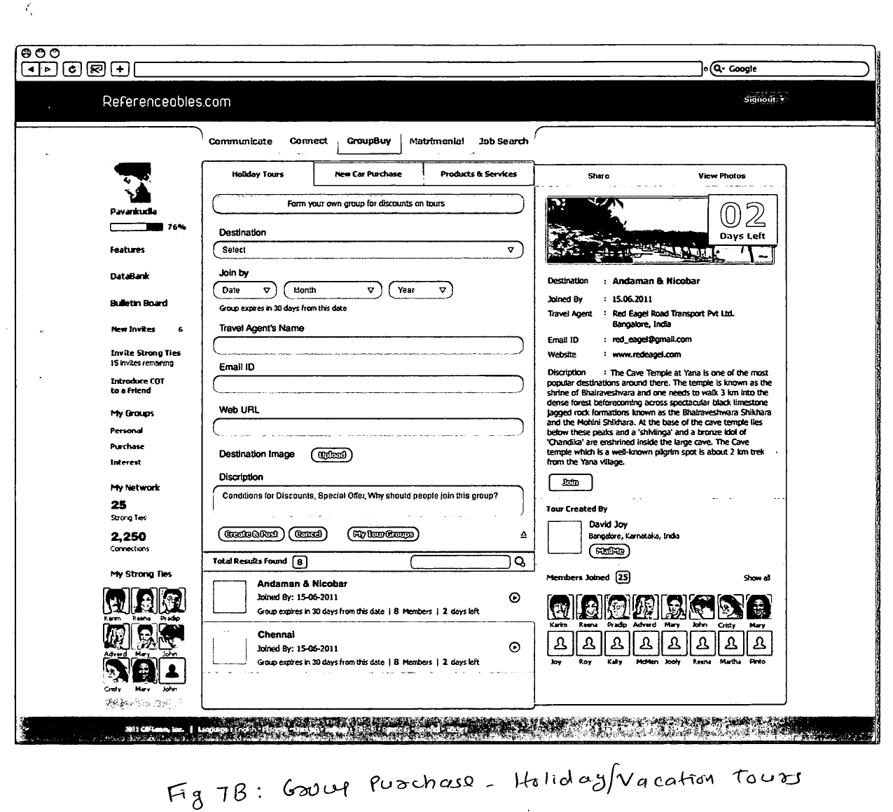

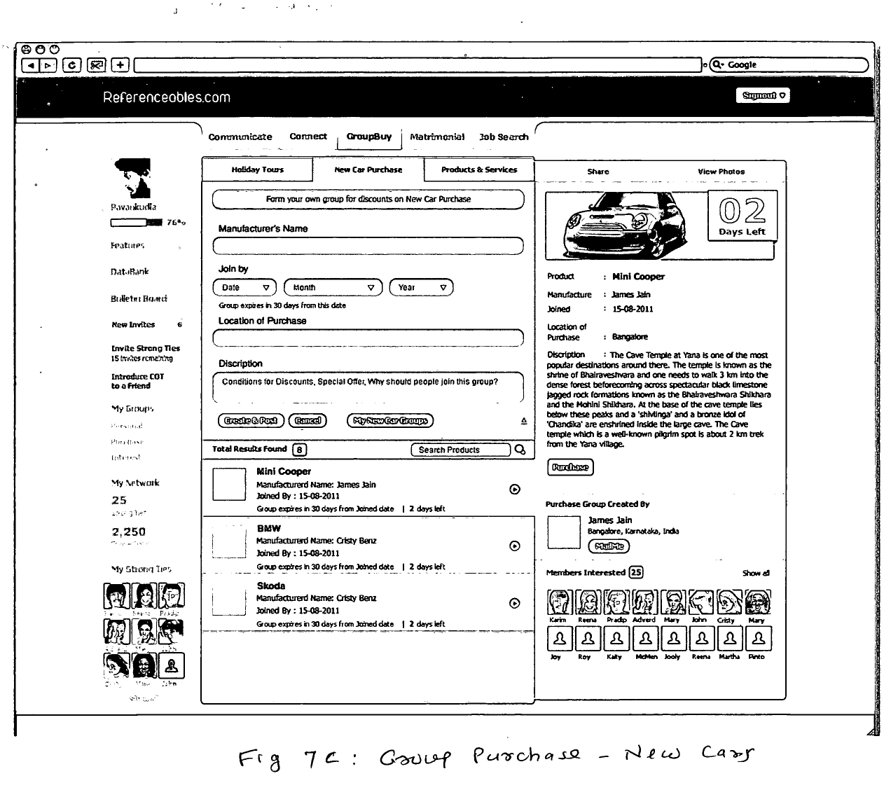

Service 200 provides yet another method to avail the benefits of group purchases. Using this method members can create or join purchase groups for products and services they wish to buy rather than waiting for group deals on said goods or services to be proposed by the merchants. This is exactly opposite to currently popular group purchase product like GroupOn. Unlike GroupOn, this service allows member to select product/service and buy at group rate. Products/services include New Car, Vacation/Holiday Tours and any high price item product or service. FIG. 7A shows a user interface active product/services purchase groups. Member can sort active purchase groups by many different ways. If member cannot find needed product/service in the needed time frame, member can create a new group. FIG. 7B shows user interface for Vacation/Holiday Tours Group purchase. FIG. 7C illustrates user interface for ‘New Car’ group purchase.

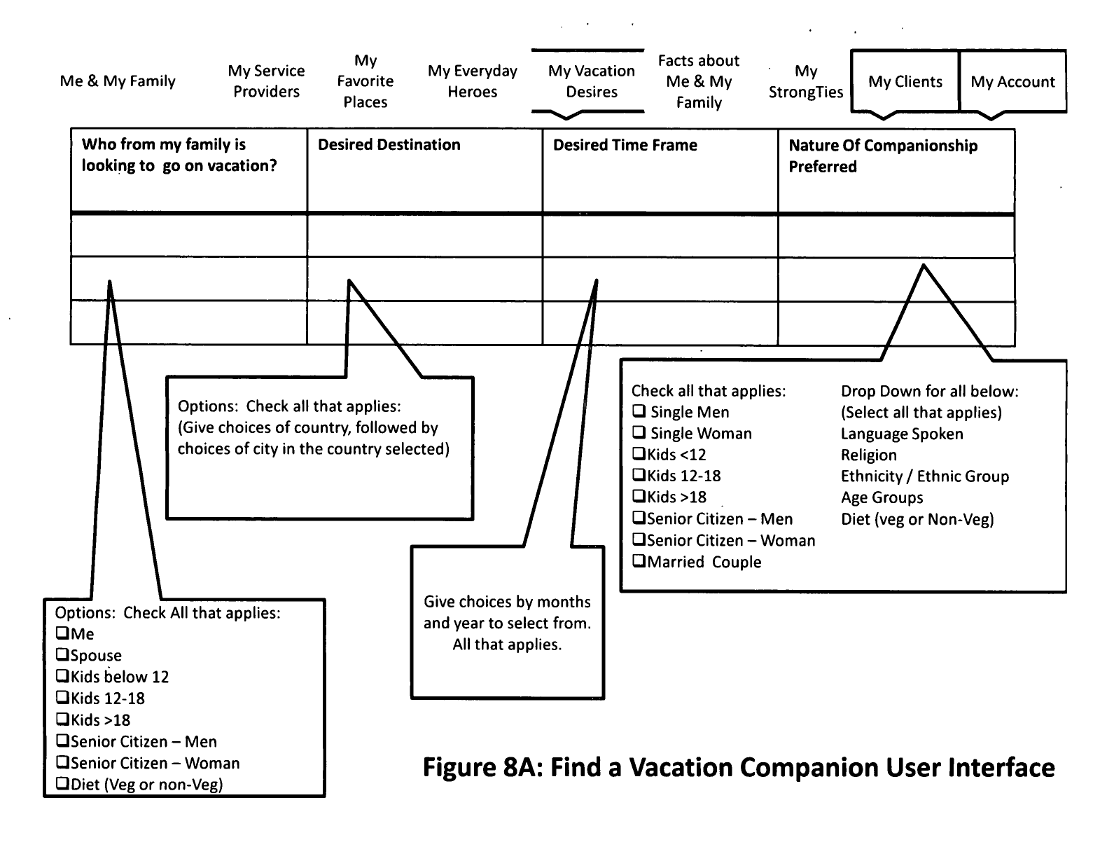

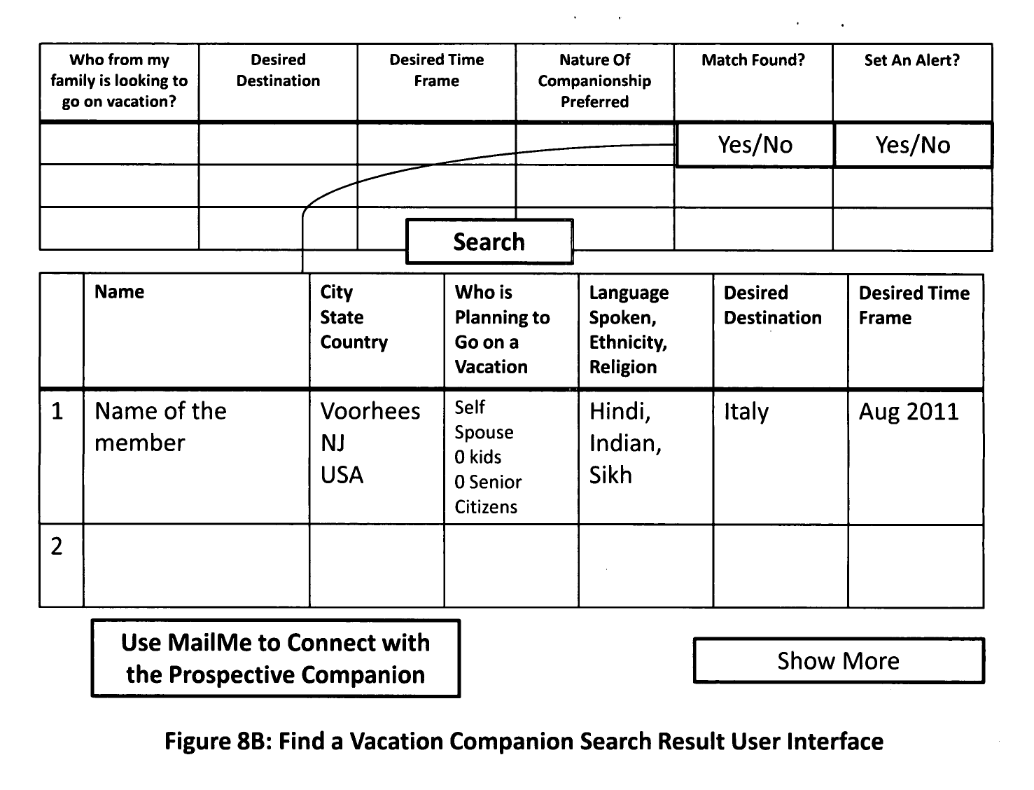

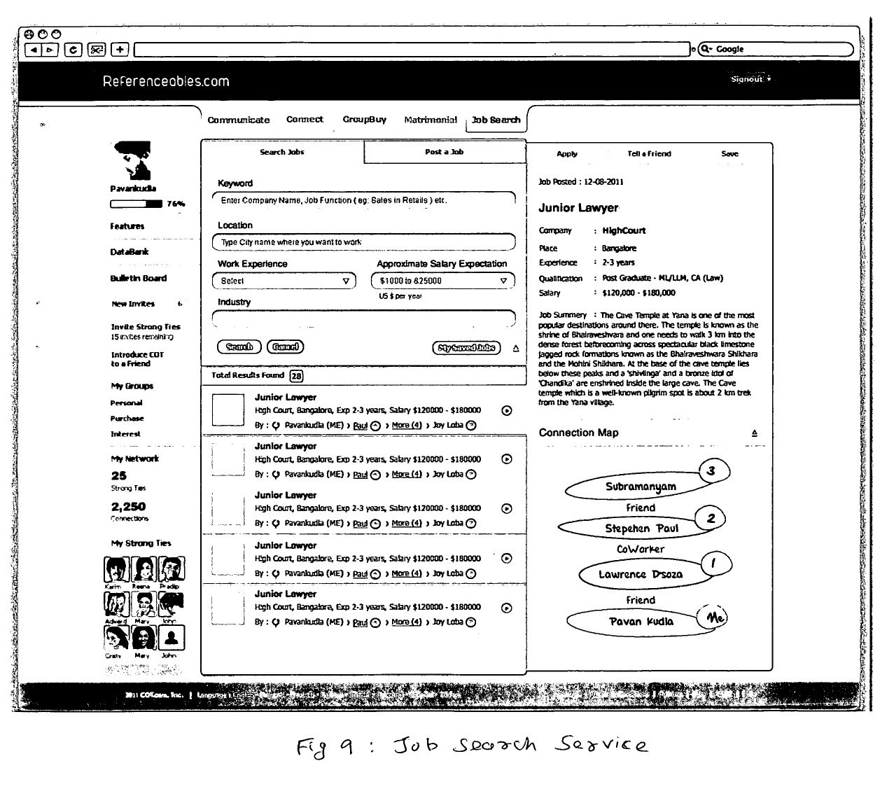

Service 200 provides yet another method whereby member can search for a companion(s) to go on Vacation/holiday tour together based on mutual preferences. FIG. 8A is a conceptual user interface which shows how a member enters companion search criteria for the search. FIG. 8B is a conceptual user interface of the search results provided by the Service 200. Service 200 also allows member to be alerted when a prospective vacation companion(s) become available.

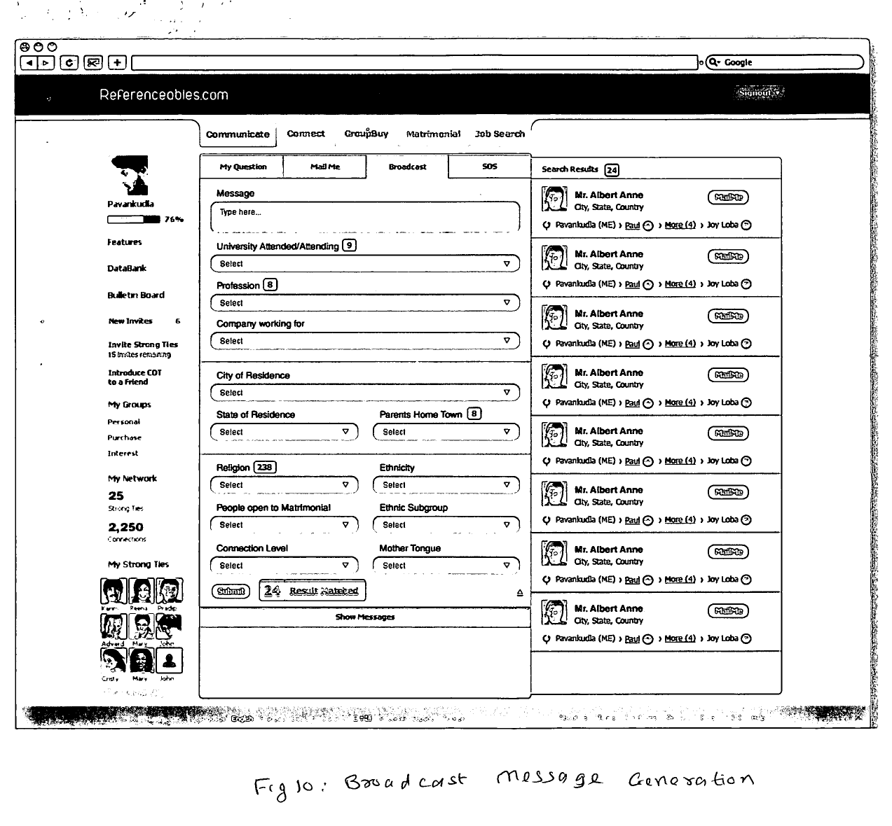

Service 200 provides yet another method to recruit for jobs. Using this method job-posters can post available jobs and employment opportunities. Using this method job seekers can search for and apply to available jobs and employment opportunities gaining information from the system about their referenceable connections with the job-poster. FIG. 9 is a user interface for job search.

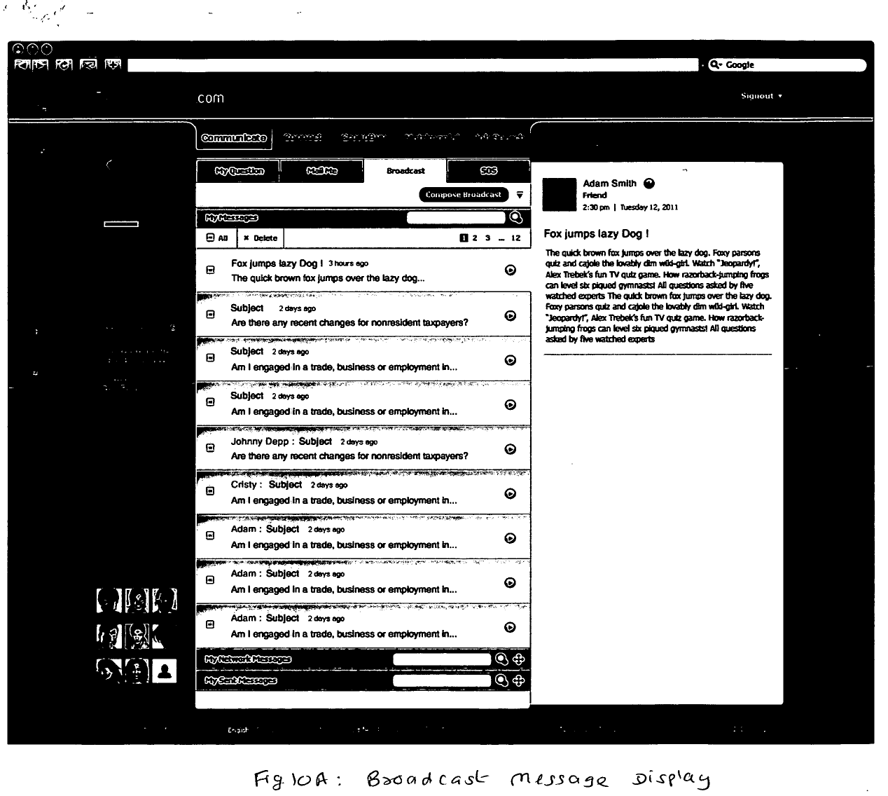

Service 200 provides yet another method to whereby members can broadcast information and messages to a group of members chosen based on selected search criteria based on personal or family background including but not limited to religion, ethnicity, geographic location, and education. FIG. 10 shows user interface for the broadcast message generation. Service 200 sends broadcast message to selected members and display messages to member based on member's strong tie connection with the sender. FIG. 10A shows this broadcast message display user interface.

Conclusion

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Method and apparatus for establishing an exclusive network of Strong Tie connections which is then used to make referenceable connections between members for various personal and business benefits comprising:
(a) A means by which each member can identify and establish a limited number of close friends, family members and/or coworkers as their direct network, referred to from here on as a Strong Tie Connections; and
(b) A means by which each of said Strong Tie Connections can then go on to identify and establish their own limited number of Strong Tie Connections and so on thereby establishing a network of referenceable connections; and
(c) A means by which members can leverage their network of referenceable connections for social and/or professional gains and/or mutual benefit; and
(d) A means by which members can access information about the basis of their relationship to another member through a network of intermediaries while maintaining appropriate confidentiality.

2. A computer implemented method as in claim 1, comprised of a social network intended for families to network with other families through their referenceable networks.

3. A computer implemented method as in claim 1, that serves to provide matrimonial matching for self or family members, said method comprised of:
(a) A means through which members can identify their matrimonial needs, and/or the needs of their family members; and
(b) A means by which members can search for suitable matches amongst the members and family members interested in matrimonial matches on the basis of search criteria focused on family background as well as personal background including but not limited to age, religion, ethnicity, profession, location, education, hometown, languages spoken, financial status, and family values.
(c) A means by which said members will be provided information about how they are connected to a potential match through a network of referenceables; and
(d) A means by which a member can show interest in connecting with another member or their family members for his/herself or for his/her family members while maintaining complete confidentiality with only the system itself gaining knowledge of said member's proposed interest until mutual interest has been established.

4. A computer implemented method as in claim 1, for members to avail the benefits of group purchases comprised of a means by which members can create or join purchase groups for products and services they wish to buy rather than waiting for group deals on said goods or services to be proposed by the merchants.

5. A computer implemented method as in claim 1, to recruit for jobs comprised of:
(a) A means by which a members can post available jobs and employment opportunities; and
(b) A means by which members can search for and apply to available jobs and employment opportunities gaining information from the system about their referenceable connections with the job-poster.

6. A computer implemented method comprised as in claim 1, of a means by which members can broadcast information and messages to a group of members chosen based on selected search criteria based on personal or family background including but not limited to religion, ethnicity, geographic location, and education.
